(19) United States
(12) Patent Application Publication
(10) Pub. No.: US 2012/0141180 A1
(43) Pub. Date: Jun. 7, 2012

(54) SURFACE TREATMENT FOR IMPROVING THE ADHESION OF PHASE CHANGE INK ON SUBSTRATES

(75) Inventors: Guiqin SONG, Milton (CA); Edward G. Zwartz, Mississauga (CA); Gordon Sisler, St. Catnarines (CA); T. Brian McAneney, Burlington (CA)

(73) Assignee: XEROX CORPORATION, Norwalk, CT (US)

(21) Appl. No.: 12/962,120

(22) Filed: Dec. 7, 2010

(51) Int. Cl. G03G 15/00

(52) U.S. Cl. 399/390

(57) ABSTRACT

Treatments are described for surfaces of substrates to improve adhesion with a phase change ink. A method of forming an image on a coated substrate with a phase change ink includes treating a surface of the coated substrate with a corona discharge treatment, a plasma treatment and/or an electron-beam treatment prior to image formation, and subsequently forming an image on the surface of the treated coated substrate with a phase change ink, wherein the image formed on the substrate has an LV Index that is reduced compared to that of an image formed on the untreated substrate. A phase change ink printing apparatus includes a corona discharge, plasma and/or electron-beam treatment device; and a phase change ink printing device, wherein the corona discharge, plasma and/or electron-beam treatment device is located upstream, in a process direction, from the phase change ink printing device.

### BACKGROUND

The present disclosure relates to surface treatment of a substrate, and more particularly to treatment of coated paper substrate for improved phase change ink adhesion via transfix.

### SUMMARY

A method for improving the surface adhesion of a phase change ink to a substrate is disclosed. The method includes treating the surface of the substrate, for example by corona discharge treatment, plasma treatment and/or electron beam treatment, prior to image formation.

An embodiment herein includes a method of forming an image on a substrate with a phase change ink, comprising treating a surface of the substrate with a corona discharge treatment, a plasma treatment and/or an electron-beam treatment prior to image formation, and subsequently forming an image on the surface of the treated substrate with a phase change ink, wherein the forming of the image comprises melting the phase change ink, jetting the melted phase change ink onto an intermediate transfer surface in image registration, and transfixing the phase change ink from the intermediate transfer surface to the treated substrate, and wherein the image formed on the substrate exhibits an LV Index that is reduced compared to an LV Index of the image formed on an untreated substrate.

A further embodiment herein includes a method of forming an image on a substrate with a phase change ink, comprising treating a surface of the substrate with a corona discharge treatment, a plasma treatment and/or an electron-beam treatment prior to image formation, wherein the treating comprises more than one application of the corona discharge treatment, the plasma treatment and/or the electron-beam treatment, or the combination of these methods and subsequently forming an image on the surface of the treated substrate with a phase change ink, wherein the image formed on the substrate exhibits an LV Index that is reduced compared to an LV Index of the image formed on an untreated substrate.

Further described is a phase change ink printing apparatus comprising a corona discharge, plasma and/or electron-beam treatment device; and a phase change ink printing device, wherein the corona discharge, plasma and/or electron-beam treatment device is located upstream, in a process direction, from the phase change ink printing device.

Additionally, a method for improving the adhesion of a phase change ink comprised of a monomer or an oligomer and a wax to a substrate by treating the surface of the substrate with a high frequency power prior to image formation with the phase change ink is discussed.

Additionally, a method of forming an image is disclosed. The method is comprised of treating the surface of a substrate with high frequency power, then jetting a melted phase change ink onto the treated surface. Finally, the phase change ink is cooled in order to solidify the ink to the treated surface.

### BRIEF DESCRIPTION OF THE DRAWINGS

FIG. 1 illustrates a graphical representation of the Lintview LV Index results for a substrate receiving 1 to 8 treatments.

FIG. 2 is a schematic of an example apparatus for use herein.

### DETAILED DESCRIPTION OF EMBODIMENTS

The use of corona discharge treatments to improve adhesion between two solid materials is described in U.S. Pat. No. 3,171,539 (disclosing the corona discharge treatment of a polyethylene film for the purpose of improving self-adhesion without the use of heat or pressure) and in U.S. Pat. No. 6,893,529 (disclosing the use of corona discharge treatment to produce laminate materials from a variety of plastic materials having among its advantages eliminating the application of adhesive primer).

The ink jet printing of phase-change inks involving an offset or transfix mechanism of transferring ink to the substrate is disclosed in U.S. Pat. No. 5,372,852, incorporated herein by reference in its entirety.

In the office environment, the typically used printing substrate is uncoated paper, generally described as xerographic bond or dual purpose bond wherein the dual purpose refers to ink jet and xerographic suitability. This class of papers is well-established in terms of properties including surface roughness, porosity, surface energy, density and compressibility affecting receptivity and adhesion of xerographic toner, aqueous ink jet and phase change ink jet inks.

There is, however, a growing desire to utilize coated papers, and additionally a trend to extend the use of office printing devices to commercial printing and graphic arts applications that favor coated paper substrates. There are fundamental differences between coated and uncoated paper properties that may affect the adhesion of ink to the substrate. Coatings essentially replace a fiber and starch carbohydrate layer with a calcium carbonate and kaolin clay mineral pigment layer. Coated paper having a 75° Gardner gloss exceeding 60 ggu (Gardner gloss units) is approximately 2-5 times smoother than xerographic or dual-purpose uncoated bond paper and has surface pores approximately 10 times smaller. The surface energy of these coated papers may be lower than uncoated bond as a result of calcium carbonate dominant at the surface. Additionally, coated papers typically have a higher thermal diffusivity, again due to a mineral pigment layer replacing a fiber layer.

These differences, including being smoother, having smaller pores, having lower surface energy and having higher thermal diffusivity, tend to reduce the adhesion of ink to the coated substrate compared to an uncoated substrate. This is especially true for phase change inks because the vehicle in liquid inks that facilitates wetting and penetration into pores is absent.

The adhesion of phase change ink to a substrate is disclosed in U.S. Pat. No. 5,372,852, incorporated herein by reference in its entirety.

Herein it is described that treatment of coated paper with corona discharge results in improved adhesion of phase-change inks applied through a transfix mechanism.

Phase change inks, also referred to as solid inks, gel inks and/or hot-melt inks, may be printed on various types of substrates such as, for example, natural fiber (for example, paper) substrates and synthetic substrates. As discussed above, paper substrates may include a coating on the surface thereof, which coating may adversely affect the adhesion of the phase change inks to the surface of the coated substrate. The treatment of the substrate, coated or uncoated, yields desirable improvements in the adhesion of the phase change inks.

Natural fiber substrates include, for example, paper and cardboard. As the paper, any suitable paper size, weight and gloss may be used. Many papers are coated such as cast coated paper, glossy coated paper, dull coated paper, matte coated paper and silk coated paper. The processes described herein are most beneficial when used in conjunction with coated papers as the substrate.

Synthetic media, for example made of specially treated plastic films, are being increasingly used for printing applications where moisture and/or contamination would damage traditional fibrous substrates. Synthetic substrates, which refer to plastic substrates, such as without limitation, polyethylene, polypropylene, poly(vinyl chloride) (PVC), polyester (PET) and mixtures thereof have become increasingly important for printing. Such plastic substrates are durable and tear resistant, and are finding increasing use in labels, tags, maps, menus, posters, manuals, books, covers and various cards such as identification cards, gift cards, credit cards, hotel key cards and the like. The use of such material technology is rapidly growing and replacing traditional fibrous substrates. Synthetic substrates surfaces may be treated prior to the phase change ink being jetted to increase the phase change ink adhesion.

Treatments

The use of corona discharge and similar methods to first treat the surface of the substrate, prior to printing, improves the subsequent adhesion of the phase change inks printed thereon, particularly where the phase change ink printing is conducted via transfix.

The treatments herein are corona discharge treatment, plasma treatment and electron beam treatment, and combinations of these treatments.

Multiple treatments, for example at least two treatments, of one method type or of a combination of method types to the substrate prior to printing with a phase change ink leads to improved phase change ink adhesion to the substrate surface. Also, the power level of the treatment may affect the required treatment time, for example the higher the power level, the less the treatment time. The substrate may be treated just prior to or up to about 48 hours before printing occurs.

The corona treatment may be carried out with any suitable method known in the art. The term “corona-discharge treated” is used herein to refer to treatment that involves the generation of an electrical discharge wherein the resulting plasma or corona is impinged upon the surface of the substrate to be treated. The resulting treated surface generally exhibits increased surface energy and improved adhesive properties. The surface treatment processes and equipment for such treatment include those described in U.S. Pat. No. 5,466,423 (Brinto et al.), U.S. Pat. No. 5,194,291 (D'Aoust et al.) and U.S. Pat. No. 4,649,097 (Tsukada et al.), all incorporated herein by reference. Conventional corona discharge treatment techniques utilize a power supply and electrode assembly. Convenient treatment units are those supplied by Enercon Industries Corp., ENI Power Systems or Corotec Corp. The corona discharge treatment is applied to the substrate at atmospheric pressure and in ambient air. The electrode geometry can be readily chosen or tailored to meet the needs of the process, depending upon the shape of the substrate, as one skilled in the art would understand. Typical corona discharge devices include, for example, a high-frequency power generator, a high-voltage transformer, a stationary electrode, and a treater ground roll.

The power level for the corona discharge treatment should be adequate to sufficiently activate the surface in a reasonable amount of time. The power level and treatment time for sufficient activation of the substrate surface, including fibrous paper and synthetic paper, are inversely related. Generally, the instantaneous power level should be between about 20 to about 500 watts, such as from about 20 to about 100 watts or from about 30 to about 50 watts. The treatment time, for a single treatment, is generally from about 10 to about 200 seconds, such as from about 15 to about 150 seconds or from about 60 to about 120 seconds. Put in terms of treatment speed, suitable treatment speeds may be from 5 inch/min to 40 inch/min. However, it should be understood from the previous discussion, that the power levels and treatment times outside these ranges may be found useful.

The corona treatment of the substrate is carried out prior to the printing of the phase change ink to the substrate. To this end, the substrate may be surface treated well in advance of the subsequent printing operation. It has been found that the treatment may be administered to the substrate hours, for example up to 24 hours, before printing. Thus, corona treatment may be done outside of the ink printing device. Alternatively, the corona treatment could also be incorporated into the device or system to treat the substrate immediately prior to printing.

Plasma treatment may also be used. Plasma treatment usually differs from corona treatment by the location of the electrodes, which are used to create the electrical discharge, relative to the substrate to be treated. Rather than sandwiching the substrate between two or more electrodes and creating a discharge with an electric field through the substrate as in corona discharge, in plasma treatment, the electrodes can be situated such that the electrical discharge occurs on one side of the media, and is impinged upon the surface of the media. Plasma treatment may be done at reduced gas pressure, less than atmospheric pressure, but atmospheric pressure is more practical. Plasma treatment is usually done with smaller electrodes and thus a smaller width of treatment area, which then requires moving the treatment electrodes across the substrate surface, or pairing of many pairs of electrodes to treat practical widths of substrates. An advantage of plasma treatment can be reduced ozone generation by better control of the voltage and current flow than in corona treatment. Other advantages include the ability to treat substrates which are thick, too conductive, too variable in width or for any other reason of non-uniformity or interruption of the corona discharge, such as due to limitations of voltage that can be generated.

Electron-beam treatment may be used to modify the media surface and is a method involving generation of electrons, acceleration of electrons under an electric field, and directing the electrons over a desired area to be treated by diverging or scanning the beam in a raster using various techniques such as varying electric or magnetic fields. Electron energies required are typically in about the 1 MeV or higher energy range, with beam current levels sufficient to provide enough power density to the area of the substrate being treated. Electron-beam treatment is similar to UV treatment in the respect of providing energy to accelerate chemical reactions, and hence modify surfaces by promoting curing or generating reactive species on the surface. Electron-beam treatment has health effects and so appropriate guards, baffles, and interlocks should be employed in such treatment systems. Also, secondary emission of x-rays from bombardment of surfaces with high energy electrons must be considered and dealt with under any appropriate standards and regulations.

Some images, such as color images, require more than one phase change ink to be jetted in order to form the image. For example, differently colored phase change inks may each be used on the same substrate surface in forming an image. The treatment of the surface of the substrate can be carried out before each differently colored phase change ink is jetted or put onto the substrate. For example, the substrate surface may be treated prior to locating a first colored phase change ink thereon, and then the substrate with the first colored phase change ink thereon treated again prior to locating a second colored phase change ink thereon.

Image Formation

The phase change inks may form an image on the substrate. The method of forming the image on the substrate includes treating a surface of the substrate that is to receive the image via corona discharge, plasma or electron-beam, then jetting the melted phase change ink directly onto the substrate or jetting the melted phase change ink onto an intermediate transfer member from which the jetted ink is subsequently transferred to the treated substrate.

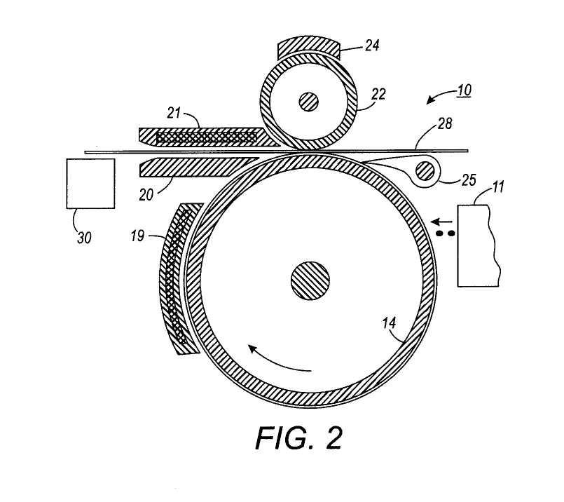

The use of an intermediate transfer member ultimately utilizes transfix in order to locate the phase change ink on the substrate. Referring to FIG. 2, the ink utilized in the process and system 10 is initially in solid form and is changed to a molten state by the application of heat energy to raise the temperature from about 60° C. to about 150° C. The molten ink is then applied from ink jets in a printhead 11 to the exposed surface of the intermediate transfer member, in this case an intermediate transfer drum 14, where the jetted ink is cooled to an intermediate temperature and solidifies or gels to a malleable state. The intermediate temperature may be between about 30° C. to about 80° C.

The intermediate transfer surface is then moved, in this case rotated, such that the jetted, malleable ink image enters the nip region 18 with fusing roller 22. In the nip, the ink is deformed to its final image conformation and adheres or is fixed to the final receiving substrate 28 either by the pressure exerted against ink image on the final receiving substrate 28 by the pressure and fusing roller 22 alone, or by the combination of the pressure and heat supplied by appropriate heating apparatus 21. This is referred to herein as transfix (the transfer and fusing of the phase change ink). Additional heating apparatus 19 or 24 could optionally be employed to supply heat to facilitate the process at this point. The pressure exerted on the ink image may be between about 10 to about 2000 pounds per square inch (psi), such as between about 500 to about 1000 psi or between about 750 to about 850 psi. The pressure must be sufficient to have the ink image adhere to the final receiving substrate 28. Once adhered to the final receiving substrate, the ink image may be cooled to ambient temperature of about 20° C. to about 25° C. Removal of the substrate 28 from the surface of the intermediate transfer member may be achieved with the assistance of removal fingers 25.

FIG. 2 also illustrates inclusion of a corona discharge treatment station 30 within the device, upstream from the nip region so that the substrate may be treated prior to receiving the jetted phase change ink. As above, the corona discharge treatment may also be affected outside of the printing device.

In the transfix zone/nip region, the phase change ink is heated to a temperature at which the storage modulus of the ink exhibits a rubbery behavior and is subjected to a pressure above the compressive yield strength of the ink. Under these conditions, the malleable ink is compressed into the substrate surface, facilitating the development of an adhesive bond through a variety of mechanisms including interfacial molecular contact, minimization of un-wetted void area, interfacial segmental diffusion, penetration into pores, and the like.

From the perspective of the functional quality of printed material, the adhesion improvement demonstrated contributes to overall image permanence or robustness. A method for testing printed image permanence that is known in the industry is the tape-pull test in which a piece of adhesive tape is affixed to the image and then removed. The test measures the force required to remove the tape and also defines the point of failure, which may be (1) at the tape print interface (adhesive failure), (2) within the printed image (cohesive failure), (3) at the print substrate interface (adhesive failure) or (4) within the substrate (substrate cohesive failure). In the case of (1), the test is unsuccessful; (2) and (3) represent two modes—cohesive and adhesive—of image permanence failure; while (4) signifies excellent image permanence. However, one of the drawbacks of tape-pull testing is variability and inability to quantify results. In the present application, a device known as the Lintview tester, developed by LabTech Instruments, has been used successfully to control variability and quantify the results accurately. The Lintview test results reported herein do not distinguish between the cohesive and adhesive modes of phase change ink failure, but this is appropriate, first from a functional quality perspective and second from a fundamental perspective because the transfix mechanism involves both interfacial adhesion and compressive malleability to achieve a bond.

The adhesion of the phase change ink can thus be measured using Lintview. The Lintview tester utilizes certified, calibrated low tack tapes, in particular NWS 400 tape, to test how much of the phase change ink is removed from the surface of the substrate. The tape peel tester contains a CCD (Charge Coupled Device) camera inside the tester that records images on the tester tape with the ink particles transferred to the surface of the prints. A CCD camera is a digital camera using a Charge Coupled Device to form images. A CCD camera is an apparatus that is designed to convert optical brightness into electrical amplitude signals using a plurality of CCDs, and then reproduce the image of a subject using the electric signals without time restriction. Software included with the tester then analyzes and calculates the ink particle size and the ink particle size distribution on the tape. The results are reported as a numeric value, based on the software analysis and calculations, on the Lintview Index (LV Index). The higher the LV Index values, the worse the adhesion of the phase change ink.

By the corona treatment described herein, the phase change ink on the treated substrate exhibits a reduced LV Index compared to the phase change ink on an untreated substrate. In embodiments, the LV Index of the phase change ink on the corona treated substrate exhibits an LV Index that is reduced by at least about 50 LV Index units compared to the phase change ink on an untreated substrate. In percentage terms, a single treatment may reduce the LV Index of the image on the substrate by, for example, about 30% or more, such as by about 40% or more, as compared to the image on an untreated substrate. With multiple treatments of the surface of the substrate, the LV Index can be reduced even further as compared to the untreated substrate, and reduced compared to a substrate treated with a fewer number of surface treatments.

In embodiments, it is desired that the phase change ink on the treated substrate exhibit an LV Index that is reduced compared to the ink on an untreated substrate as discussed above, and is at least about 195 or less, such as 170 or less and 150 or less. When the substrate is subjected to multiple treatments, LV Index is desirably 170 or less. When the printed phase change ink on the substrate has an LV Index within the specified ranges, the printed image demonstrates improved permanence or robustness, for example as compared to the same phase change ink printed on a non-treated substrate.

Phase Change Inks

The treated substrates exhibit improved adhesion with phase change inks. An exemplary phase change ink composition includes an ink vehicle and a colorant. In particular, exemplary compositions of phase change inks for use herein are inks that include an ink vehicle that is solid at temperatures of about 20° C. to about 27° C., for example room temperature, and specifically are solid at temperatures below about 40° C. However, the inks change phase upon heating, and are in a molten state at jetting temperatures. Thus, the inks have a viscosity of from about 1 to about 20 centipoise (cp), for example from about 5 to about 15 cp or from about 8 to about 12 cp, at an elevated temperature suitable for ink jet printing, for example temperatures of from about 60° C. to about 180° C.

In this regard, all of the inks suitable for use herein may be either low energy inks or high energy inks. Low energy inks are solid at a temperature below about 40° C. and have a viscosity of from about 5 to about 15 centipoise at a jetting temperature of from about 80° C. to about 150° C., for example from about 90° C. to about 130° C. or from about 110° C. to about 120° C. High energy inks are solid at a temperature below 40° C. and have a viscosity of from about 5 to about 15 centipoise at a jetting temperature of from about 100° C. to about 180° C., for example from 120° C. to about 160° C. or from about 125° C. to about 150° C.

The inks may have melting points of from about 50° C. to about 150° C., for example from about 80° C. to about 120° C. or from about 85° C. to about 110° C., as determined by, for example, observation and measurement on a microscope hot stage, wherein an ink material is heated on a glass slide and observed by microscope. Higher melting points are also acceptable, although printhead life may be reduced at temperatures higher than 150° C.

In addition, the surface tension of the vehicle at the operating (jetting) temperature of the ink should be from about 20 to about 65 dynes per centimeter, for example from about 40 to about 65 dynes per centimeter, to enhance refill rates, paper wetting, and color mixing.

Any suitable ink vehicle can be employed in any of the phase change inks disclosed herein. Suitable vehicles can include paraffins, microcrystalline waxes, polyethylene waxes, ester waxes, fatty acids and other waxy materials, fatty amide containing materials, sulfonamide materials, resinous materials made from different natural sources (tall oil rosins and rosin esters, for example), and many synthetic resins, oligomers, polymers, and copolymers such as further discussed below.

As used herein, the term wax includes, for example, natural, modified natural, synthetic waxes and compounded waxes.

Natural waxes may be of vegetable, animal, or mineral origin. Modified waxes are natural waxes that have been treated chemically to change their nature and properties. Synthetic waxes are made by the reaction or polymerization of chemicals. Compounded waxes are mixtures of various waxes or of waxes with resins or other compounds added thereto.

Examples of suitable waxes include polypropylenes and polyethylenes commercially available from Allied Chemical and Baker Petrolite Corporation, wax emulsions available from Michaelman Inc. and the Daniels Products Company, EPOLENE N-15 commercially available from Eastman Chemical Products, Inc., VISCOL 550-P, a low weight average molecular weight polypropylene available from Sanyo Kasei K.K., and similar materials. The commercially available polyethylenes selected usually possess a molecular weight of from about 1,000 to about 1,500, while the commercially available polypropylenes utilized for the ink compositions herein are believed to have a molecular weight of from about 4,000 to about 5,000. Examples of suitable functionalized waxes include, for example, amines, amides, imides, esters, quaternary amines, carboxylic acids or acrylic polymer emulsion, for example JONCRYL waxes such as 74, 89, 130, 537, and 538, all available from SC Johnson Wax, chlorinated polypropylenes and polyethylenes commercially available from Allied Chemical and Baker Petrolite Corporation and SC Johnson wax.

The wax in embodiments is a distilled polyethylene wax such as described in U.S. Pat. No. 7,381,254, incorporated herein by reference in its entirety, for example a polyethylene wax having an average peak molecular weight of from about 350 to about 730 and a polydispersity of from about 1.0001 to about 1.500.

Suitable phase change ink waxes include hydroxyl-terminated polyethylene waxes such as mixtures of carbon chains with the structure CH₃—(CH₂)ₙ—CH₂OH, where there is a mixture of chain lengths, n, where the average chain length is in the range of about 16 to about 50, and linear low molecular weight polyethylene, of similar average chain length. Suitable examples of such waxes include, for example, UNILIN® 350, UNILIN® 425, UNILIN® 550 and UNILIN® 700 with number average molecular weights approximately equal to 375, 460, 550 and 700 g/mol, respectively. All of these waxes are commercially available from Baker Petrolite.

Other suitable phase change ink waxes include alcohol waxes, for example, hydrogenated castor oil, 1-octadecanol, 1,10-decanediol and 1,12-dodecanediol. Other examples of mono functional alcohols that can be employed as phase change ink waxes herein include 1-tetradecanol, 1-pentadecanol, 1-hexadecanol, 1-heptadecanol, 1-nonadecanol, 1-eicosanol, 1-tricosanol, 1-tetracosanol, 1-pentacosanol, 1-hexacosanol, 1-heptacosanol, 1-octacosanol, 1-nonacosanol, 1-tricontanol, 1-dotriacontanol, 1-tritriacontanol, 1-tetratriacontanol. Also suitable are Guerbet alcohols such as 2-tetradecyl 1-octadecanol, 2-hexadecyl 1-eicosanol, 2-octadecyl 1-docosanol, 2-nonadecyl 1-tricosanol, 2-eicosyl tetracosanol, and mixtures thereof. Suitable diols include 1,8-octanediol, 1,9-nonanediol, 1,13-tridecanediol, 1,14-tetradecanediol, 1,15-pentadecanediol, 1,16-hexandecanediol, 1,17-heptadecanediol, 1,18-octadecanediol, 1,19-nonadecanediol, 1,20-eicosanediol, 1,22-docosanediol, 1,25-pentacosanediol, and mixtures thereof.

In embodiments, the phase change ink includes a urethane wax, an alcohol wax, an olefin wax, or a combination thereof.

Other suitable phase change ink waxes include carboxylic acid waxes, for example, UNICID® 350, UNICID® 425, UNICID® 550, UNICID® 700, with number average molecular weights approximately equal to 390, 475, 565 and 720 g/mol, respectively. All of these waxes are commercially available from Baker Petrolite.

The ability of the wax to crystallize contributes to its overall hardness, which imparts strength to the ink. The degree of crystallization can be controlled by regulating the degree of branching (that is, irregularity) of the wax. A high degree of linearity of the wax chain, such as a polyethylene chain, generally yields a highly crystalline and hard material.

In embodiments, the wax is functionalized with one or more curable moieties, including, for example, vinyl ethers; epoxides, such as cycloaliphatic epoxides, aliphatic epoxides, and glycidyl epoxides; oxetanes; (meth)acrylates, that is, acrylates and methacrylates; and the like.

Additional examples of suitable ink vehicles include, for example, ethylene/propylene copolymers, such as those available from Baker Petrolite and of the general formula

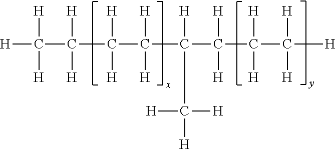

wherein y represents an integer from 0 to about 30, for example from 0 to about 20 or from 0 to about 10 and x is equal to about 21-y. The copolymers may have, for example, a melting point of from about 70° C. to about 150° C., such as from about 80° C. to about 130° C. or from about 90° C. to about 120° C. and a molecular weight range of from about 500 to about 4,000. Commercial examples of such copolymers include, for example, PETROLITE CP-7 (Mn=650), PETROLITE CP-11 (Mn=1,100, PETROLITE CP-12 (Mn=1,200) and the like.

Urethane derivatives of oxidized synthetic or petroleum waxes, such as those available from Baker Petrolite and of the general formulas

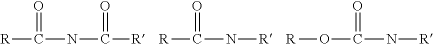

wherein R is an alkyl group of the formula CH₃(CH₂)ₙ, n is an integer of from about 5 to about 400, for example from about 10 to about 300 or from about 20 to about 200 and R′ is a tolyl group, may also be used as the ink vehicle. These materials may have a melting point of from about 60° C. to about 120° C., such as from about 70° C. to about 100° C. or from about 70° C. to about 90° C. Commercial examples of such materials include, for example, PETROLITE CA-11 (Mn=790, Mw/Mn=2.2), PETROLITE WB-5 (Mn=650, Mw/Mn=1.7), PETROLITE WB-17 (Mn=730, Mw/Mn=1.8), and the like.

Another type of ink vehicle may be n-paraffinic, branched paraffinic, and/or naphthenic hydrocarbons, typically with from about 5 to about 100, such as from about 20 to about 180 or from about 30 to about 60 carbon atoms, generally prepared by the refinement of naturally occurring hydrocarbons, such as BE SQUARE 185 and BE SQUARE 195, with molecular weights (Mn) of from about 100 to about 5,000, such as from about 250 to about 1,000 or from about 500 to about 800, for example such as available from Baker Petrolite.

Highly branched hydrocarbons, typically prepared by olefin polymerization, such as the VYBAR materials available from Baker Petrolite, including VYBAR 253 (Mn=520), VYBAR 5013 (Mn=420), and the like, may also be used. In addition, the ink vehicle may be an ethoxylated alcohol, such as available from Baker Petrolite and of the general formula

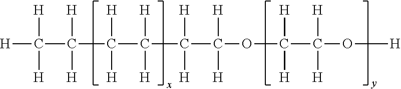

wherein x is an integer of from about 1 to about 50, such as from about 5 to about 40 or from about 11 to about 24 and y is an integer of from about 1 to about 70, such as from about 1 to about 50 or from about 1 to about 40. The materials may have a melting point of from about 60° C. to about 150° C., such as from about 70° C. to about 120° C. or from about 80° C. to about 110° C. and a molecular weight (Mn) range of from about 100 to about 5,000, such as from about 500 to about 3,000 or from about 500 to about 2,500. Commercial examples include UNITHOX 420 (Mn=560), UNITHOX 450 (Mn=900), UNITHOX 480 (Mn=2,250), UNITHOX 520 (Mn=700), UNITHOX 550 (Mn=1,100), UNITHOX 720 (Mn=875), UNITHOX 750 (Mn=1,400), and the like.

As an additional example, the ink vehicle may be made of fatty amides, such as monoamides, triamides, tetra-amides, mixtures thereof, and the like, for example such as described in U.S. Pat. No. 6,858,070, U.S. Pat. No. 6,174,937, and U.S. Pat. No. 6,860,930, incorporated herein by reference. Suitable monoamides may have a melting point of at least about 50° C., for example from about 50° C. to about 150° C., although the melting point can be below this temperature. Specific examples of suitable monoamides include, for example, primary monoamides and secondary monoamides. Stearamide, such as KEMAMIDE S available from Witco Chemical Company and CRODAMIDE S available from Croda, behenamide/arachidamide, such as KEMAMIDE B available from Witco and CRODAMIDE BR available from Croda, oleamide, such as KEMAMIDE U available from Witco and CRODAMIDE OR available from Croda, technical grade oleamide, such as KEMAMIDE O available from Witco, CRODAMIDE O available from Croda, and UNISLIP 1753 available from Uniqema, and erucamide such as KEMAMIDE E available from Witco and CRODAMIDE ER available from Croda, are some examples of suitable primary amides. Behenyl behenamide, such as KEMAMIDE EX666 available from Witco, stearyl stearamide, such as KEMAMIDE S-180 and KEMAMIDE EX-672 available from Witco, stearyl erucamide, such as KEMAMIDE E-180 available from Witco and CRODAMIDE 212 available from Croda, erucyl erucamide, such as KEMAMIDE E-221 available from Witco, oleyl palmitamide, such as KEMAMIDE P-181 available from Witco and CRODAMIDE 203 available from Croda, and erucyl stearamide, such as KEMAMIDE S-221 available from Witco, are some examples of suitable secondary amides. Additional suitable amide materials include KEMAMIDE W40 (N,N′-ethylenebisstearamide), KEMAMIDE P181 (oleyl palmitamide), KEMAMIDE W45 (N,N′-ethylenebisstearamide), and KEMAMIDE W20 (N,N′-ethylenebisoleamide).

High molecular weight linear alcohols, such as those available from Baker Petrolite and of the general formula

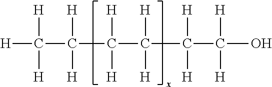

wherein x is an integer of from about 1 to about 50, such as from about 5 to about 35 or from about 11 to about 23, may also be used as the ink vehicle. These materials may have a melting point of from about 50° C. to about 150° C., such as from about 70° C. to about 120° C. or from about 75° C. to about 110° C., and a molecular weight (Mn) range of from about 100 to about 5,000, such as from about 200 to about 2,500 or from about 300 to about 1,500. Commercial examples include the UNILIN materials such as UNILIN 425 (Mn=460), UNILIN 550 (Mn=550), UNILIN 700 (Mn=700), and the like.

A still further example includes hydrocarbon-based waxes, such as the homopolymers of polyethylene available from Baker Petrolite and of the general formula

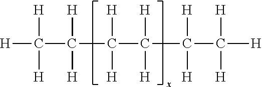

wherein x is an integer of from about 1 to about 200, such as from about 5 to about 150 or from about 12 to about 105. These materials may have a melting point of from about 60° C. to about 150° C., such as from about 70° C. to about 140° C. or from about 80° C. to about 130° C. and a molecular weight (Mn) of from about 100 to about 5,000, such as from about 200 to about 4,000 or from about 400 to about 3,000. Example waxes include the line of waxes, such as POLYWAX 500 (Mn=500), POLYWAX 655 (Mn=655), POLYWAX 850 (Mn=850), POLYWAX 1000 (Mn=1,000), and the like.

Another example includes modified maleic anhydride hydrocarbon adducts of polyolefins prepared by graft copolymerization, such as those available from Baker Petrolite and of the general formulas

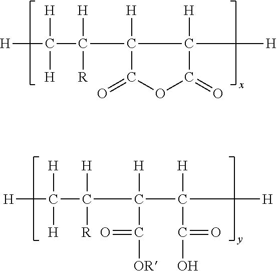

wherein R is an alkyl group with from about 1 to about 50, such as from about 5 to about 35 or from about 6 to about 28 carbon atoms, R′ is an ethyl group, a propyl group, an isopropyl group, a butyl group, an isobutyl group, or an alkyl group with from about 5 to about 500, such as from about 10 to about 300 or from about 20 to about 200 carbon atoms, x is an integer of from about 9 to about 13, and y is an integer of from about 1 to about 50, such as from about 5 to about 25 or from about 9 to about 13, and having melting points of from about 50° C. to about 150° C., such as from about 60° C. to about 120° C. or from about 70° C. to about 100° C.; those available from Baker Petrolite and of the general formula

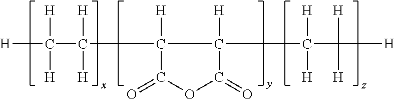

wherein R is an alkyl group with from about 1 to about 50, such as from about 5 to about 35 or from about 6 to about 28 carbon atoms, x is an integer of from about 1 to about 50, such as from about 5 to about 25 or from about 9 to about 13, y is 1 or 2, and z is an integer of from about 1 to about 50, such as from about 5 to about 25 or from about 9 to about 13; and those available from Baker Petrolite and of the general formula

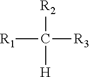

wherein R₁ and R₃ are hydrocarbon groups and R₂ is either of one of the general formulas

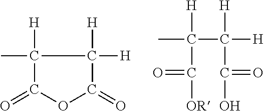

or a mixture thereof, wherein R′ is an isopropyl group, which materials may have melting points of from about 70° C. to about 150° C., such as from about 80° C. to about 130° C. or from about 90° C. to about 125° C., with examples of modified maleic anhydride copolymers including CERAMER 67 (Mn=655, Mw/Mn=1.1), CERAMER 1608 (Mn=700, Mw/Mn=1.7), and the like.

Additional examples of suitable ink vehicles for the phase change inks include rosin esters; polyamides; dimer acid amides; epoxy resins, such as EPOTUF 37001, available from Riechold Chemical Company; fluid paraffin waxes; fluid microcrystalline waxes; Fischer-Tropsch waxes; polyvinyl alcohol resins; polyols; cellulose esters; cellulose ethers; polyvinyl pyridine resins; fatty acids; fatty acid esters; poly sulfonamides, including KETJENFLEX MH and KETJENFLEX MS80; benzoate esters, such as BENZOFLEX 5552, available from Velsicol Chemical Company; phthalate plasticizers; citrate plasticizers; maleate plasticizers; sulfones, such as diphenyl sulfone, n-decyl sulfone, n-arnyl sulfone, chlorophenyl methyl sulfone; polyvinyl pyrrolidinone copolymers; polyvinyl pyrrolidone/polyvinyl acetate copolymers; novolac resins, such as DUREZ 12 686, available from Occidental Chemical Company; and natural product waxes, such as beeswax, monton wax, candelilla wax, GILSONITE (American Gilsonite Company), and the like; mixtures of linear primary alcohols with linear long chain amides or fatty acid amides, such as those with from about 6 to about 24 carbon atoms, including PARICIN 9 (propylene glycol monohydroxystearate), PARICIN 13 (glycerol monohydroxystearate), PARICIN 15 (ethylene glycol monohydroxystearate), PARICIN 220 (N(2-hydroxyethyl)-12-hydroxystearamide), PARICIN 285 (N,N′-ethylene-bis-12-hydroxystearamide), FLEXRICIN 185 (N,N′-ethylene-bis-ricinoleamide), and the like. Further, linear long chain sulfones with from about 4 to about 16 carbon atoms, such as n-propyl sulfone, n-pentyl sulfone, n-hexyl sulfone, n-heptyl sulfone, n-octyl sulfone, n-nonyl sulfone, n-decyl sulfone, n-undecyl sulfone, n-dodecyl sulfone, n-tridecyl sulfone, n-tetradecyl sulfone, n-pentadecyl sulfone, n-hexadecyl sulfone, and the like, are suitable ink vehicle materials.

In addition, the ink vehicles described in U.S. Pat. No. 6,906,118, incorporated herein by reference, may also be used. Also suitable as ink vehicles are liquid crystalline materials as disclosed in, for example, U.S. Pat. No. 5,122,187, the disclosure of which is totally incorporated herein by reference.

The ink vehicle may comprise from about 5% to about 95% by weight of the ink, for example from about 10% to about 85% or from about 20% to about 75% by weight of the ink.

The phase change ink may also include one or more gelling agents, as known in the art. The gelling agent may be, for example, the gelling agents disclosed in U.S. Pat. No. 7,279,587, incorporated herein by reference in its entirety.

The ink can include the gelling agent, or gellant, in any suitable amount, such as about 1% to about 30% by weight of the ink, for example in an amount of about 2% to about 20% by weight of the ink, such as about 5% to about 12% by weight of the ink.

Phase change inks may also contain at least one colorant, desirably a non-fluorescent colorant. As used herein “colorant” includes pigment, dye, mixtures of dyes, mixtures of pigments, mixtures of dyes and pigments, and the like. The colorant may be present an ink in any desired amount, typically from about 0.5 to about 75 percent by weight of the ink vehicle, for example from about 1 to about 50 percent by weight of the ink vehicle.

Any pigment may be chosen, provided that it is capable of being dispersed or dissolved in the ink vehicle and is compatible with the other ink components. Examples of suitable pigments include, for example, Violet PALIOGEN Violet 5100 (BASF); PALIOGEN Violet 5890 (BASF); HELIOGEN Green L8730 (BASF); LITHOL Scarlet D3700 (BASF); SUNFAST® Blue 15:4 (Sun Chemical 249-0592); Hostaperm Blue B2G-D (Clariant); Permanent Red P-F7RK; Hostaperm Violet BL (Clariant); LITHOL Scarlet 4440 (BASF); Bon Red C (Dominion Color Company); ORACET Pink RF (Ciba); PALIOGEN Red 3871 K (BASF); SUNFAST® Blue 15:3 (Sun Chemical 249-1284); PALIOGEN Red 3340 (BASF); SUNFAST® Carbazole Violet 23 (Sun Chemical 246-1670); LITHOL Fast Scarlet L4300 (BASF); Sunbrite Yellow 17 (Sun Chemical 275-0023); HELIOGEN Blue L6900, L7020 (BASF); Sunbrite Yellow 74 (Sun Chemical 272-0558); SPECTRA PAC® C Orange 16 (Sun Chemical 276-3016); HELIOGEN Blue K6902, K6910 (BASF); SUNFAST® Magenta 122 (Sun Chemical 228-0013); HELIOGEN Blue D6840, D7080 (BASF); Sudan Blue OS (BASF); NEOPEN Blue FF4012 (BASF); PV Fast Blue B2GO1 (Clariant); IRGALITE Blue BCA (Ciba); PALIOGEN Blue 6470 (BASF); Sudan Orange G (Aldrich), Sudan Orange 220 (BASF); PALIOGEN Orange 3040 (BASF); PALIOGEN Yellow 152, 1560 (BASF); LITHOL Fast Yellow 0991 K (BASF); PALIOTOL Yellow 1840 (BASF); NOVOPERM Yellow FGL (Clariant); Lumogen Yellow D0790 (BASF); Suco-Yellow L1250 (BASF); Suco-Yellow D1355 (BASF); Suco Fast Yellow D355, D1 351 (BASF); HOSTAPERM Pink E 02 (Clariant); Hansa Brilliant Yellow 5GX03 (Clariant); Permanent Yellow GRL 02 (Clariant); Permanent Rubine L6B 05 (Clariant); FANAL Pink D4830 (BASF); CINQUASIA Magenta (DU PONT), PALIOGEN Black L0084 (BASF); Pigment Black K801 (BASF); and carbon blacks such as REGAL 330™ (Cabot), Carbon Black 5250, Carbon Black 5750 (Columbia Chemical), mixtures thereof and the like. Examples of suitable dyes include Usharect Blue 86 (Direct Blue 86), available from Ushanti Color; Intralite Turquoise 8GL (Direct Blue 86), available from Classic Dyestuffs; Chemictive Brilliant Red 7BH (Reactive Red 4), available from Chemiequip; Levafix Black EB, available from Bayer; Reactron Red H8B (Reactive Red 31), available from Atlas Dye-Chem; D&C Red #28 (Acid Red 92), available from Warner-Jenkinson; Direct Brilliant Pink B, available from Global Colors; Acid Tartrazine, available from Metrochem Industries; Cartasol Yellow 6GF Clariant; Carta Blue 2GL, available from Clariant; and the like.

The ink compositions may optionally contain pigments, which are typically cheaper and more robust than dyes, may be included in particular embodiments. The compositions can be used in combination with conventional ink-colorant materials, such as Color Index (C.I.) Solvent Dyes, Disperse Dyes, modified Acid and Direct Dyes, Basic Dyes, Sulphur Dyes, Vat Dyes, and the like.

Examples of suitable dyes include Neozapon Red 492 (BASF); Orasol Red G (Ciba); Direct Brilliant Pink B (Oriental Giant Dyes); Direct Red 3BL (Classic Dyestuffs); Supranol Brilliant Red 3BW (Bayer AG); Lemon Yellow 6G (United Chemie); Light Fast Yellow 3G (Shaanxi); Aizen Spilon Yellow C-GNH (Hodogaya Chemical); Bernachrome Yellow GD Sub (Classic Dyestuffs); Cartasol Brilliant Yellow 4GF (Clariant); Cibanon Yellow 2GN (Ciba); Orasol Black CN (Ciba); Savinyl Black RLSN (Clariant); Pyrazol Black BG (Clariant); Morfast Black 101 (Rohm & Haas); Diaazol Black RN (ICI); Orasol Blue GN (Ciba); Savinyl Blue GLS (Clariant); Luxol Fast Blue MBSN (Pylam Products); Sevron Blue 5GMF (Classic Dyestuffs); Basacid Blue 750 (BASF), Neozapon Black X51 (BASF), Classic Solvent Black 7 (Classic Dyestuffs), Sudan Blue 670 (C.I. 61554) (BASF), Sudan Yellow 146 (C.I. 12700) (BASF), Sudan Red 462 (C.I. 26050) (BASF), C.I. Disperse Yellow 238, Neptune Red Base NB543 (BASF, C.I. Solvent Red 49), Neopen Blue FF-4012 from BASF, Lampronol Black BR from ICI (C.I. Solvent Black 35), Morton Morplas Magenta 36 (C.I. Solvent Red 172), metal phthalocyanine colorants such as those disclosed in U.S. Pat. No. 6,221,137, the disclosure of which is totally incorporated herein by reference, and the like. Polymeric dyes can also be used, such as those disclosed in, for example, U.S. Pat. No. 5,621,022 and U.S. Pat. No. 5,231,135, the disclosures of each of which are herein entirely incorporated herein by reference, and commercially available from, for example, Milliken & Company as Milliken Ink Yellow 869, Milliken Ink Blue 92, Milliken Ink Red 357, Milliken Ink Yellow 1800, Milliken Ink Black 8915-67, uncut Reactant Orange X-38, uncut Reactant Blue X-17, Solvent Yellow 162, Acid Red 52, Solvent Blue 44, and uncut Reactant Violet X-80.

Pigments are also suitable colorants for the phase change inks. Examples of suitable pigments include PALIOGEN Violet 5100 (commercially available from BASF); PALIOGEN Violet 5890 (commercially available from BASF); HELIOGEN Green L8730 (commercially available from BASF); LITHOL Scarlet D3700 (commercially available from BASF); SUNFAST Blue 15:4 (commercially available from Sun Chemical); Hostaperm Blue B2G-D (commercially available from Clariant); Hostaperm Blue B4G (commercially available from Clariant); Permanent Red P-F7RK; Hostaperm Violet BL (commercially available from Clariant); LITHOL Scarlet 4440 (commercially available from BASF); Bon Red C (commercially available from Dominion Color Company); ORACET Pink RF (commercially available from Ciba); PALIOGEN Red 3871 K (commercially available from BASF); SUNFAST Blue 15:3 (commercially available from Sun Chemical); PALIOGEN Red 3340 (commercially available from BASF); SUNFAST Carbazole Violet 23 (commercially available from Sun Chemical); LITHOL Fast Scarlet L4300 (commercially available from BASF); SUNBRITE Yellow 17 (commercially available from Sun Chemical); HELIOGEN Blue L6900, L7020 (commercially available from BASF); SUNBRITE Yellow 74 (commercially available from Sun Chemical); SPECTRA PAC C Orange 16 (commercially available from Sun Chemical); HELIOGEN Blue K6902, K6910 (commercially available from BASF); SUNFAST Magenta 122 (commercially available from Sun Chemical); HELIOGEN Blue D6840, D7080 (commercially available from BASF); Sudan Blue OS (commercially available from BASF); NEOPEN Blue FF4012 (commercially available from BASF); PV Fast Blue B2GO1 (commercially available from Clariant); IRGALITE Blue BCA (commercially available from Ciba); PALIOGEN Blue 6470 (commercially available from BASF); Sudan Orange G (commercially available from Aldrich), Sudan Orange 220 (commercially available from BASF); PALIOGEN Orange 3040 (BASF); PALIOGEN Yellow 152, 1560 (commercially available from BASF); LITHOL Fast Yellow 0991 K (commercially available from BASF); PALIOTOL Yellow 1840 (commercially available from BASF); NOVOPERM Yellow FGL (commercially available from Clariant); Ink Jet Yellow 4G VP2532 (commercially available from Clariant); Toner Yellow HG (commercially available from Clariant); Lumogen Yellow D0790 (commercially available from BASF); Suco-Yellow L1250 (commercially available from BASF); Suco-Yellow D1355 (commercially available from BASF); Suco Fast Yellow D1 355, D1351 (commercially available from BASF); HOSTAPERM Pink E 02 (commercially available from Clariant); Hansa Brilliant Yellow 5GX03 (commercially available from Clariant); Permanent Yellow GRL 02 (commercially available from Clariant); Permanent Rubine L6B 05 (commercially available from Clariant); FANAL Pink D4830 (commercially available from BASF); CINQUASIA Magenta (commercially available from DU PONT); PALIOGEN Black L0084 (commercially available from BASF); Pigment Black K801 (commercially available from BASF); and carbon blacks such as REGAL 330™ (commercially available from Cabot), Nipex 150 (commercially available from Degusssa) Carbon Black 5250 and Carbon Black 5750 (commercially available from Columbia Chemical), and the like, as well as mixtures thereof.

The colorant may be included in the ink composition in an amount of from, for example, about 0.1 to about 15% by weight of the ink composition, such as about 2.0 to about 9% by weight of the ink composition.

The benefit of corona treatment on a surface of a substrate is shown herein. A corona treatment was carried out using an Electro-Technics Products, Incorporated Model BD-20 handheld high frequency corona generator (50/60 Hz, with spring electrode tip, operated at 10,000 to 50,000 V with 4-5 MHz output frequency). The treatment speed may be from 5 inch/min to 40 inch/min. Table 1 illustrates how the LV Index value decreases as the number of treatments increases. The phase change ink used was a low melt phase change ink, 100% cyan Lance Ink, printed on 120 grams per square meters Digital Color Elite Gloss, printed using a ColorCube 9203 (a Xerox phase change ink color multifunction printer with an intermediate drum transfer member). The Digital Color Elite Gloss coated paper was corona treated before the printing. Multiple treatments were done on the paper at a speed of 22 inches per minute.

TABLE 1

| Number of Corona Treatments | LV Index |
|---|---|
| 0 | 249.0 |
| 1 | 191.4 |
| 2 | 166.6 |
| 4 | 148.6 |
| 8 | 139.3 |

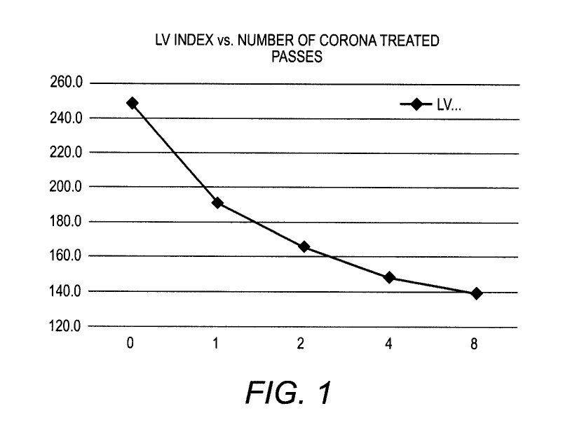

The results from Table 1 are further illustrated in FIG. 1, which is a graphical representation of the results. As can be seen, the LV index decreased with the increase of number of corona treatments, which means the ink adhesion on substrate was dramatically improved with additional treatments, particularly as compared to an untreated substrate.

Table 2 illustrates the LV Index results for three different substrates, which are gloss coated papers, when receiving a corona treatment compared to not receiving a corona treatment and printed upon using a ColorCube 9203. The same low melt ink as above was used. The results in Table 2 illustrate that the LV Index is lowered and phase change ink adhesion improves on all three gloss coated papers after the corona treatment.

TABLE 2

| | LV Index with | LV Index with |
|---|---|---|
| | no Corona | Single Corona |
| Substrate | Treatment | Treatment |
| DCEG 100# Text | 166.9 | 101.3 |
| 130 gsm Celestrial Gloss | 239.4 | 137.1 |
| Sappi Lustro Gloss 100# Text | 184.1 | 130.6 |

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A method of forming an image on a substrate with a phase change ink comprising:
treating a surface of the substrate with a corona discharge treatment, a plasma treatment and/or an electron-beam treatment prior to image formation, and
subsequently forming an image on the surface of the treated substrate with a phase change ink,
wherein the forming of the image comprises melting the phase change ink, jetting the melted phase change ink onto an intermediate transfer surface in image registration, and transfixing the phase change ink from the intermediate transfer surface to the treated substrate, and
wherein the image formed on the substrate exhibits an LV Index that is reduced compared to an LV Index of the image formed on an untreated substrate.

2. The method according to claim 1, wherein the image formed on the substrate exhibits an LV Index that is reduced by at least about 50 LV Index units compared to the LV Index of the image formed on an untreated substrate.

3. The method according to claim 2, wherein the image formed on the substrate exhibits an LV Index that does not exceed about 195.

4. The method according to claim 1, wherein the substrate is cast coated paper, gloss coated paper, silk coated paper, matte coated paper or dull coated paper.

5. The method according to claim 1, wherein the substrate comprises paper coated with a calcium carbonate and kaolin clay mineral pigment layer.

6. The method according to claim 1, wherein the substrate is a synthetic substrate selected from the group consisting of polyethylene film, polypropylene film, polyvinyl chloride film and polyester film.

7. The method according to claim 1, wherein the corona discharge treatment is conducted with a corona discharge device that comprises a high-frequency power generator, a high-voltage transformer, a stationary electrode, and a treater ground roll.

8. The method according to claim 1, wherein the treating of the substrate and the forming of the image is done within a same printing device.

9. The method according to claim 1, wherein the phase change ink is comprised of at least one wax and at least one colorant.

10. The method according to claim 9, wherein the phase change ink is further comprised of at least one gelling agent.

11. The method according to claim 1, wherein the phase change ink has a melting point of from about 50° C. to about 150° C.

12. A method of forming an image on a substrate with a phase change ink comprising:
treating a surface of the substrate with a corona discharge treatment, a plasma treatment and/or an electron-beam treatment prior to image formation, wherein the treating comprises more than one application of the corona discharge treatment, the plasma treatment and/or the electron-beam treatment, and
subsequently forming an image on the surface of the treated substrate with a phase change ink,
wherein the image formed on the substrate exhibits an LV Index that is reduced compared to an LV Index of the image formed on an untreated substrate.

13. The method according to claim 12, wherein the image formed on the substrate exhibits an LV Index that is reduced by at least about 50 LV Index units compared to the LV Index of the image formed on an untreated substrate.

14. The method according to claim 12, wherein the image formed on the substrate exhibits an LV Index that does not exceed about 170.

15. The method according to claim 12, wherein the substrate is cast coated, gloss coated, silk coated, matte coated or dull coated paper.

16. The method according to claim 12, wherein the substrate comprises paper coated with a calcium carbonate and kaolin clay mineral pigment layer.

17. The method according to claim 12, wherein the substrate is a synthetic substrate selected from the group consisting of polyethylene film, polypropylene film, polyvinyl chloride film and polyester film.

18. The method according to claim 12, wherein the forming of the image comprises melting the phase change ink, jetting the melted phase change ink onto an intermediate transfer surface in image registration, and transfixing the phase change ink from the intermediate transfer surface to the treated substrate.

19. A phase change ink printing apparatus comprising:
a corona discharge, plasma and/or electron-beam treatment device; and
a phase change ink printing device,
wherein the corona discharge, plasma and/or electron-beam treatment device is located upstream, in a process direction, from the phase change ink printing device.

20. The apparatus according to claim 19, wherein the phase change ink printing device comprises a printhead, an intermediate transfer member for receiving phase change ink jetted from the printhead, and a fusing roll that contacts the intermediate transfer member downstream from the printhead in the process direction to form a nip region wherein the phase change ink is transfixed from the intermediate transfer member to a substrate, and wherein the substrate is fed through the corona discharge, plasma and/or electron-beam treatment device to receive a surface treatment, and is subsequently fed through the nip region to receive the phase change ink image.
